(19) United States
(12) Patent Application Publication
(10) Pub. No.: US 2013/0080583 A1
(43) Pub. Date: Mar. 28, 2013

(54) IMAGE PROCESSING APPARATUS, METHOD OF CONTROLLING THE SAME, AND STORAGE MEDIUM

(71) Applicant: Toshiyuki Takagi, Kawasaki-shi (JP)

(72) Inventor: Toshiyuki Takagi, Kawasaki-shi (JP)

(73) Assignee: CANON KABUSHIKI KAISHA, Tokyo (JP)

(21) Appl. No.: 13/618,216

(22) Filed: Sep. 14, 2012

(30) Foreign Application Priority Data
Sep. 28, 2011 (JP) 2011-213378

(51) Int. Cl. G06F 15/16

(52) U.S. Cl. 709/217

(57) ABSTRACT

An image processing apparatus includes a transmission control unit configured to control to transmit, to an external apparatus, display content data and screen data, the screen data describes information of a display screen to display the display content data by a browser of the external apparatus. In a case that modified data is transmitted as the display content data, the transmission control unit transmits the screen data including a restriction order to restrict, out of functions incorporated in the browser, at least a function of saving the display content data.

### BACKGROUND OF THE INVENTION

1. Field of the Invention

The present invention relates to an image processing apparatus, a method of controlling the same, and a storage medium, more particularly, relates to a technique of transmitting an image.

2. Description of the Related Art

Along with the proliferation of information-communication terminals such as a personal computer (PC) to ordinary households, it has become common to browse Web pages on the Internet using a Web browsing application (to be referred to as a browser hereinafter). Web page browsing is performed by causing a browser to access a server specified by a URL, send a file transmission request, receive a file transmitted from the server in response to the transmission request, and display the file on a display device.

A general Web page is formed as a document file described in a markup language such as HTML. The browser interprets the language, thereby generating a display image to be displayed on the display device. The Web page can also include a link to an image. Upon determining by interpreting the Web page that a link to an image exists, the browser sends an image transmission request to the server in accordance with the link and receives the image to be included in the display image.

In addition to the PCs, there also exist information-communication terminals such as cellular phones and game machines capable of using the Internet in recent years. A cellular phone or a game machine can reproduce files in only limited formats and sizes, unlike a PC. For this reason, some items may be undisplayed upon browsing a Web page. Japanese Patent Laid-Open No. 2002-91862 discloses a data distribution apparatus which, upon receiving an image data transmission request from an information terminal, transmits image data resized in accordance with the image display size allowable by the information terminal.

However, when image data to which resize processing is applied on the server size that has received an image data transmission request is transmitted to an information-communication terminal, as in Japanese Patent Laid-Open No. 2002-91862, the following problem arises. For example, if the user of the information-communication terminal wants to save the image data and print it, the saved image data may have a resolution unsuitable for printing because it is resized for the information-communication terminal. That is, saving resized image data is supposedly not in consonance with the user's intention when considering use of saved image data.

### SUMMARY OF THE INVENTION

The present invention has been made in consideration of the above-described problem of the related art. The present invention provides avoiding image saving unintended by a user.

The present invention in its first aspect provides an image processing apparatus capable of communicating with an external apparatus having a Web browser, comprising: a storage control unit configured to store content data in a storage medium; and a transmission control unit configured to control to transmit, to the external apparatus, display content data and screen data, the screen data describes information of a display screen to display the display content data by the Web browser of the external apparatus, wherein in a case that the content data stored in the storage medium satisfies a predetermined condition, the transmission control unit transmits the content data as the display content data, and in a case that the content data stored in the storage medium does not satisfy the predetermined condition, the transmission control unit transmits modified data generated by modifying the content data as the display content data, and in a case that the modified data is transmitted as the display content data, the transmission control unit transmits the screen data including a restriction order to restrict, out of functions incorporated in the Web browser, at least a function of saving the display content data in the external apparatus.

Further features of the present invention will become apparent from the following description of exemplary embodiments (with reference to the attached drawings).

### BRIEF DESCRIPTION OF THE DRAWINGS

FIG. 1 is a view showing the system arrangement of an image browsing system according to an embodiment of the present invention;

FIG. 2 is a block diagram showing the functional arrangement of a digital camera 100 according to the embodiment of the present invention;

FIG. 3 is a block diagram showing the functional arrangement of a PC 200 according to the embodiment of the present invention;

FIG. 4 is a sequence chart showing processing concerning image browsing according to the embodiment of the present invention;

FIGS. 5A, 5B, 5C, and 5D are views showing image browsing screens according to the embodiment of the present invention; and

FIG. 6 is a flowchart of image browsing screen generation processing according to the embodiment of the present invention.

### DESCRIPTION OF THE EMBODIMENTS

### Embodiment

An exemplary embodiment of the present invention will now be described in detail with reference to the accompanying drawings. Note that in an embodiment to be described below, an example will be explained in which the present invention is applied to a digital camera that is an example of an image processing apparatus capable of receiving an image transmission request from an information-communication terminal and transmitting an image specified by the request and a document that describes a control order to display the image. However, the present invention is applicable to an arbitrary device capable of receiving an image transmission request from an information-communication terminal and transmitting an image specified by the request and a control order to display the image.

<System Arrangement>

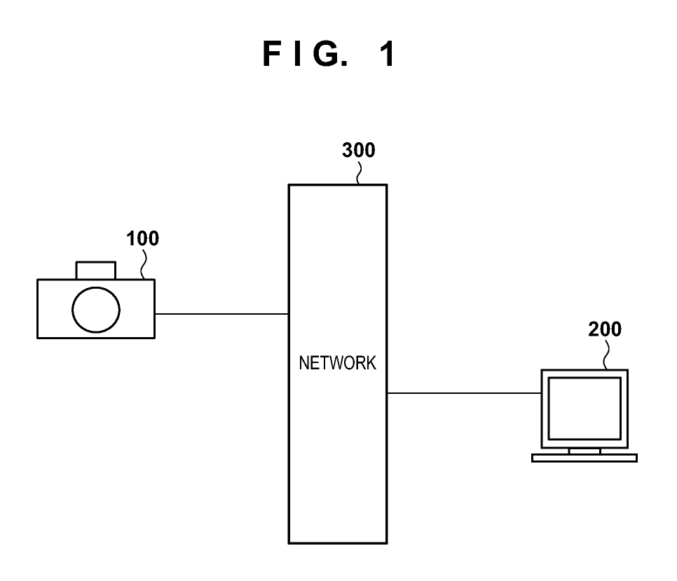

FIG. 1 is a view showing the system arrangement of an image browsing system according to an embodiment of the present invention. As shown in FIG. 1, a digital camera 100 and a PC 200 serving as an information-communication terminal are connected to a network 300. In this embodiment, the PC 200 is connected to the digital camera 100 via the network 300. The user of the PC 200 browses images stored in a storage medium 110 of the digital camera 100 using a browser.

In this embodiment, the digital camera 100 and the PC 200 are connected via the network 300 such as the Internet or a LAN (Local Area Network). However, the terminals may be connected directly.

<Functional Arrangement of Digital Camera 100>

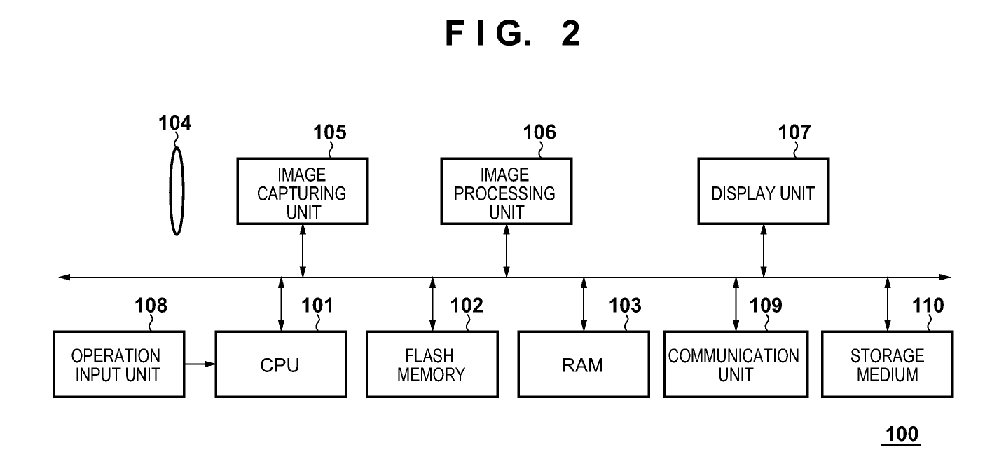

FIG. 2 is a block diagram showing the functional arrangement of the digital camera 100 according to this embodiment.

A CPU 101 controls the operations of the blocks of the digital camera 100. More specifically, the CPU 101 controls the operations of the blocks by reading out the processing program of image browsing screen generation processing (to be described later) stored in a flash memory 102, extracting the program on a RAM 103, and executing it.

The flash memory 102 is a rewritable nonvolatile memory, and stores parameters necessary for the operations of the blocks and information such as settings of the digital camera 100 in addition to the processing program of image browsing screen generation processing. In this embodiment, the flash memory 102 stores programs to cause the digital camera 100 to function as an HTTP server.

The RAM 103 is a volatile memory and is used not only as an area to extract the processing program but also as an area to temporarily store intermediate data and the like output in the operations of the blocks.

An image capturing unit 105 is an image sensor such as a CCD or CMOS sensor, and photoelectrically converts an optical image formed on the image sensor via an optical system 104 to generate an analog image signal. The image capturing unit 105 also applies A/D conversion processing to the analog image signal, thereby outputting a digital image signal (image) to an image processing unit 106.

The image processing unit 106 executes image processing such as resize processing and coding processing to an image input from the image capturing unit 105 or an image read out from the storage medium 110 to be described later.

A display unit 107 is a display device such as a small LCD provided on the digital camera 100. The display unit 107 displays an analog image signal generated by the image capturing unit 105 or an analog image signal read out from the storage medium 110 and having undergone D/A conversion processing.

An operation input unit 108 is a user interface such as a power button and a release button provided on the digital camera 100. When the user operates the user interface, the operation input unit 108 transmits a control signal corresponding to the operation to the CPU 101.

A communication unit 109 is an interface to connect the digital camera 100 to the network 300, and performs an operation concerning communication in accordance with a predetermined protocol. In this embodiment, when functioning as an HTTP server, the digital camera 100 receives a request from the PC 200 via the communication unit 109 and transmits HTML files and images. Note that the communication unit 109 may be detachable from the digital camera 100, and the HTTP server function may be provided on the side of the communication unit 109.

The storage medium 110 is, for example, an internal memory of the digital camera 100 or a storage device such as a memory card or an HDD detachably connected to the digital camera 100. The storage medium 110 stores, for example, an image obtained by causing the image processing unit 106 to execute coding processing for an image.

<Functional Arrangement of PC 200>

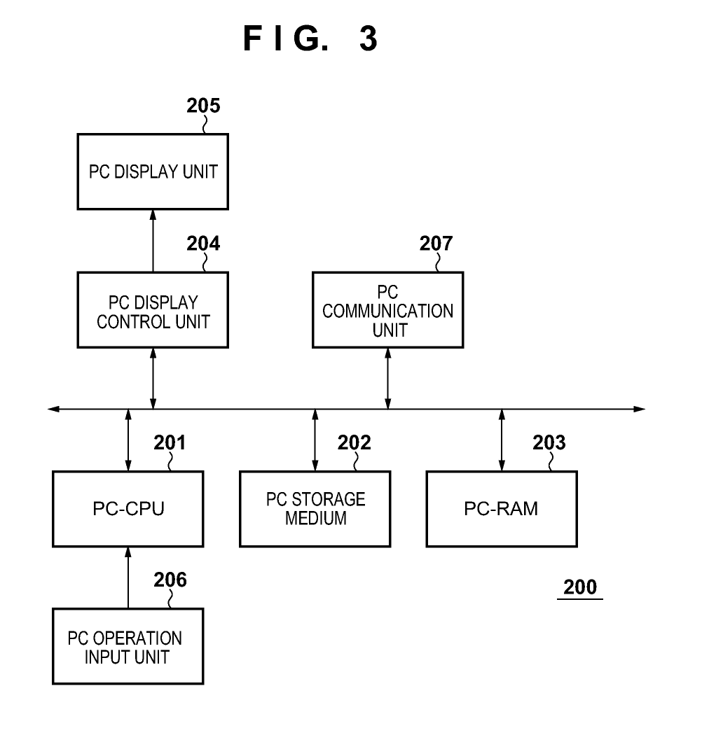

FIG. 3 is a block diagram showing the functional arrangement of the PC 200 according to this embodiment. Note that in this embodiment, a prefix “PC” is added to the blocks of the PC 200 for distinction from the blocks of the digital camera 100.

A PC-CPU 201 controls the operations of the blocks of the PC 200, execution of applications, and the like. More specifically, the PC-CPU 201 controls the operations of the blocks by reading out programs concerning various kinds of applications including an OS and a browser stored in, for example, a PC storage medium 202, extracting the programs on a PC-RAM 203, and executing them.

The PC storage medium 202 is a storage device such as an HDD or SSD detachably connected to the PC 200, and stores data of the operating system (OS) of the PC 200 and various kinds of applications.

The PC-RAM 203 is a volatile memory and is used not only as an area to extract the programs upon executing the OS or various kinds of applications but also as an area to temporarily store data and the like output upon executing the OS or various kinds of applications.

A PC display unit 205 is a display device such as an LCD incorporated in the PC 200 or a display device detachably connected to the PC 200, and displays a display image generated upon executing the OS or various kinds of applications. Display of a display image on the PC display unit 205 is controlled by a PC display control unit 204. More specifically, the PC display control unit 204 controls the output timing and the like of a display image based on the information of a set refresh rate and display resolution to display the image on the PC display unit 205.

A PC operation input unit 206 is a user interface such as a keyboard and a mouse connected to the PC 200. The PC operation input unit 206 transmits a control signal corresponding to the contents of a user operation to the PC-CPU 201.

A PC communication unit 207 is an interface to connect the PC 200 to the network 300, and performs an operation concerning communication in accordance with a predetermined protocol. In this embodiment, when the digital camera 100 functions as an HTTP server, and the user accesses the address of the digital camera 100 using a browser, a message such as an image transmission request is transmitted via the PC communication unit 207.

<Image Browsing Sequence>

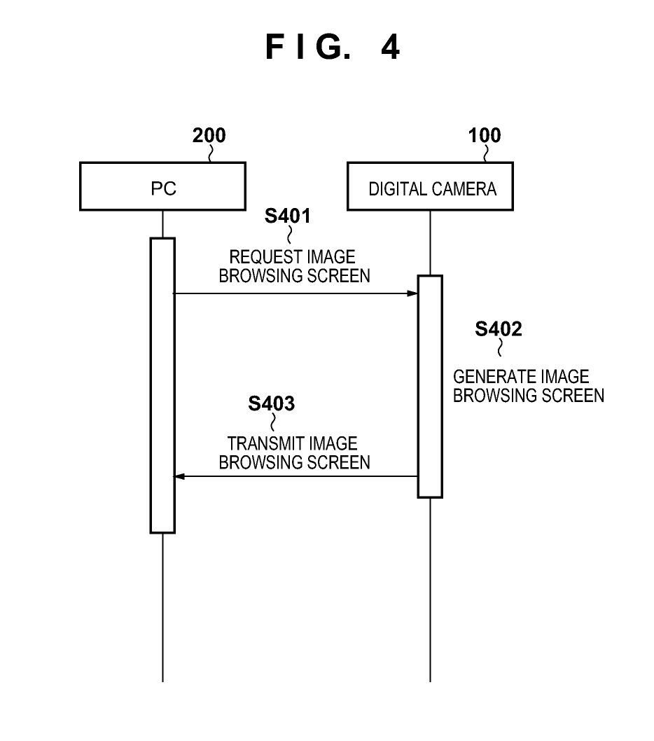

The procedure of processing concerning image browsing in the image browsing system according to the embodiment having the above-described embodiment will be explained with reference to the sequence chart of FIG. 4. FIG. 4 illustrates a case in which, for example, the user activates the browser in the PC 200, accesses the digital camera 100 functioning as an HTTP server, and browses images stored in the storage medium 110 of the digital camera 100. Note that in this sequence chart, the digital camera 100 executes the above-described program that causes the digital camera to function as an HTTP server and functions as an HTTP server. In this embodiment, an HTML document is browsed using a Web browser. Another description language or browser may be used as a matter of course.

When the user inputs, to the PC 200, an instruction to display the browsing page of a specific image, the PC 200 transmits an image browsing screen transmission request to the digital camera 100 in step S401.

In step S402, upon receiving the image browsing screen transmission request from the PC 200, the digital camera 100 creates a screen to browse the image stored in the storage medium 110 and specified by the request. Upon receiving the image browsing screen transmission request from the PC 200, the digital camera 100 of this embodiment creates a document having the HTML format in which the image to be browsed is arranged, as will be described later in detail. This embodiment assumes a case in which the user browses the image on the browser. For example, when the user selects a link to a specific image, a page to browse the image is opened on the Web browser.

In step S403, the digital camera 100 transmits the browsing screen created in step S402 to the PC 200.

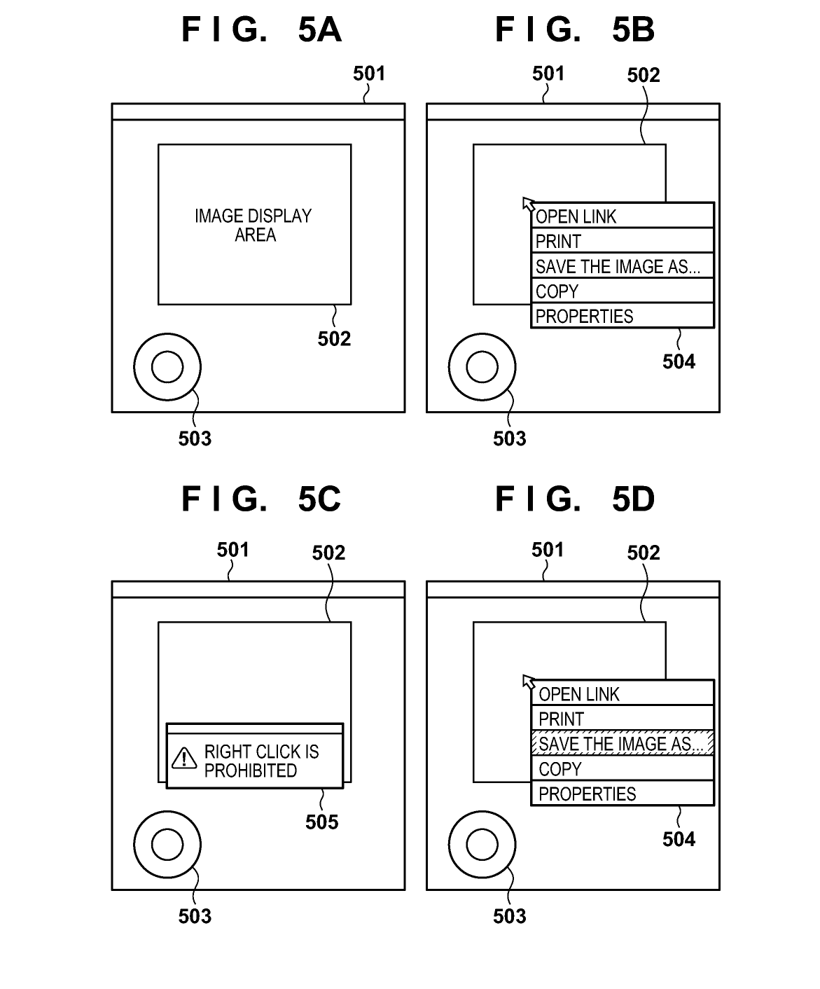

When the thus transmitted browsing screen is displayed on the PC display unit 205 of the PC 200, the user can browse the requested image. Note that the PC display unit 205 displays a display screen as shown in FIG. 5A at this time. An area 502 to display an image is provided in a window 501 of the Web browser. A save button 503 is also displayed in the browsing screen. The save button is transmitted from the digital camera 100 and displayed upon interpreting the HTML document. That is, a function of saving an image is offered by the digital camera 100. When the save button 503 is pressed by a user operation, the PC 200 requests the image from the digital camera 100 based on information associated with the save button 503.

Note that when the user places the mouse cursor on the area 502 of the screen shown in FIG. 5A and clicks the right mouse button, a menu 504 is displayed as a function of the Web browser. FIG. 5B shows an example of the menu. When the user selects “Save the image As . . . ” on this menu, the image displayed in the area 502 is saved. Note that this function does not particularly depend on the communication partner and is provided in the Web browser on the side of the PC 200 in advance. Upon detecting the mouse cursor located on the image data, the Web browser can display the menu 504 and save the displayed image. This point is different from save by the save button 503 offered by the digital camera side.

<Image Browsing Screen Generation Processing>

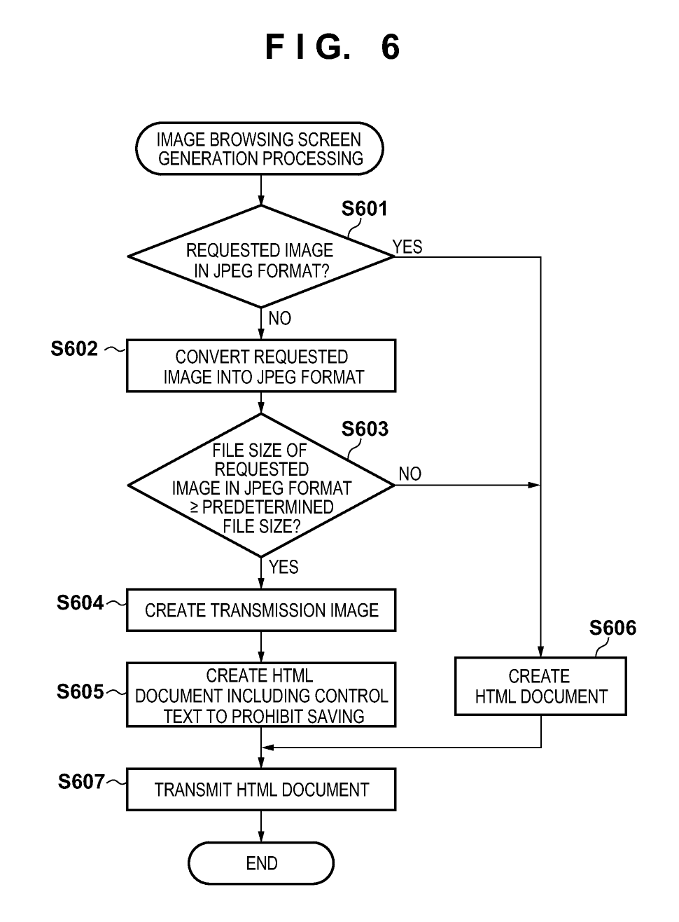

Details of image browsing screen generation processing of the digital camera 100 according to the embodiment having the above-described arrangement will be described with reference to the flowchart of FIG. 6. Processing corresponding to this flowchart can be implemented by causing the CPU 101 to read out a corresponding processing program stored in, for example, the flash memory 102, extract the program on the RAM 103, and execute it. Note that the image browsing screen generation processing starts when, for example, the CPU 101 has determined that the communication unit 109 has received an image browsing screen transmission request from the PC 200.

In step S601, the CPU 101 determines whether the image specified by the image browsing screen transmission request is stored in the JPEG format (predetermined file format). More specifically, the CPU 101 reads out the header portion of the requested image specified by the transmission request received from the PC 200 and stored in the storage medium 110 and determines whether the image has the JPEG format. Upon determining that the requested image is stored in the JPEG format, the CPU 101 advances the process to step S606. Upon determining that the image is stored in a file format other than the JPEG format (other than the predetermined file format), the CPU 101 advances the process to step S602.

In step S602, the CPU 101 converts the requested image to generate an image having the JPEG format. More specifically, the CPU 101 reads out the requested image from the storage medium 110, transmits it to the image processing unit 106, and causes it to convert the image into an image having the JPEG format. For example, if the requested image is a RAW image, the CPU 101 causes the image processing unit 106 to perform, for the requested image, predetermined development processing and then coding processing into the JPEG format, thereby generating the requested image in the JPEG format. The CPU 101 also gives a file name to the requested image in the JPEG format generated by the conversion and stores it in the storage medium 110.

In step S603, the CPU 101 determines whether the file size of the requested image in the JPEG format stored in the storage medium 110 in step S602 is larger than a predetermined file size. The information of the predetermined file size is stored in, for example, the flash memory 102. The CPU 101 reads out the information and compares it with the file size of the requested image in the JPEG format. Upon determining that the file size of the requested image in the JPEG format is larger than the predetermined file size, the CPU 101 advances the process to step S604. Upon determining that the file size is not larger than the predetermined file size, the CPU 101 advances the process to step S606.

In step S604, the CPU 101 applies image processing to the requested image in the JPEG format, thereby generating the requested image in the JPEG format whose file size is not larger than the predetermined file size. More specifically, the CPU 101 reads out the requested image converted into the JPEG format from the storage medium 110, transmits it to the image processing unit 106, and causes the image processing unit 106 to apply image processing. The image processing is, for example, resize processing, coding processing using a higher file compression ratio, or processing of reducing the file size. The image processing unit 106 applies such image processing to the input requested image converted into the JPEG format, thereby generating a transmission image having a file size not larger than the predetermined file size and storing it in the storage medium 110.

In step S605, the CPU 101 creates a document corresponding to an image browsing screen including a control order to display the transmission image. Note that at this time, the CPU 101 includes, in the document corresponding to the image browsing screen, a control order to prohibit transmission image saving by the function of the Web browser when the image browsing screen and the transmission image are displayed on the PC display unit 205 of the PC 200.

For example, if the transmission image has a file name “IMG001.jpg” and exists in the directory of the same level as the document “IMG001.html” corresponding to the image browsing screen, a control order such as
<img src=“./IMG001.jpg”>

is normally included as an image display order. When the document is interpreted by the PC 200 and displayed on the PC display unit 205, the image browsing screen as shown in FIG. 5A is generated.

In this embodiment, not a simple image display order but a control order including a prefix, such as
<img src=“./IMG001.jpg” oncontextmenu=“alert(‘ERROR’);return false”>

is used as an image display order. When the user attempts to display the menu by the function of the Web browser by operating the mouse, placing the pointer on the area 502, and clicking the right mouse button in the screen shown in FIG. 5A on the PC display unit 205, the control order prohibits display of the menu. More specifically, when the user clicks the right mouse button, control is performed to output a warning 505 to notify him/her that the right click is prohibited, as shown in FIG. 5C. Alternatively, control may be performed to prohibit selection by graying out “Save the image As . . . ” upon right click, as shown in FIG. 5D. The description of the control order changes depending on how to prohibit the display.

With this arrangement, when a transmission image is generated by applying image processing of reducing the file size or the number of pixels, the digital camera 100 of this embodiment can prohibit the user from directly saving the transmission image. Note that if the user wants to save the original image, he/she operates the above-described save button 503 so that the PC 200 can receive the image from the digital camera 100.

Upon determining in step S601 that the file format of the requested image is the JPEG format of in step S604 that the file size of the requested image converted into the JPEG format is not larger than the predetermined size, the CPU 101 performs processing of step S606. In step S606, the CPU 101 does not include a control order to prohibit saving by the function of the Web browser in the HTML document that describes the image browsing screen. In this case, when the user clicks the right mouse button, “Save the image As . . . ” is selectably displayed, as shown in FIG. 5B.

In step S607, the CPU 101 transmits the created HTML document to the PC 200 via the communication unit 109 and ends the processing. Note that the image to be displayed on the image browsing screen can be acquired when the PC 200 that has interpreted the HTML document automatically requests the image from the digital camera 100.

In the above-described embodiment, when the file format of the image is not the JPEG format, and the file size after the conversion into the JPEG format is larger than a predetermined size, image saving by the function of the Web browser is prohibited. However, the target to be prohibited from being saved by the function of the Web browser is not limited to this. For example, when an image different from the original image is transmitted to the terminal that has sent the browsing request, image saving by the function of the Web browser may be prohibited. In this case, the target to be prohibited from being saved by the function of the Web browser can be a converted image that is generated by image processing to satisfy a predetermined condition because at least one of the file size, the number of pixels, and the file format does not satisfy the predetermined condition. That is, the present invention need only have an arrangement for transmitting a control order to prohibit image saving by the function of the Web browser together when at least one of the file size, the number of pixels, and the file format of a converted image is different from that of an original image that is the target of the transmission request.

In addition, the present invention may prohibit image saving by the function of the Web browser in an arrangement for transmitting a thumbnail image or an image generated from one frame upon receiving a request to browse not an image but a moving image.

Conversion of an image that is the target of a browsing request may be performed when, for example, the transfer time necessary for transmission of an image having a desired image quality is not shorter than a predetermined time because of the transfer speed between the digital camera 100 and the PC 200 even if the above-described condition is satisfied. For example, when the communication path between the digital camera 100 and the PC 200 has established, the communication unit 109 measures the transfer speed on the path. The CPU 101 then performs the determination based on the transfer speed and the file size of the image as the target of the browsing request. The CPU 101 may cause the image processing unit 106 to generate a converted image simply when the transfer speed is not more than a predetermined threshold. When the transfer speed is not more than a predetermined threshold, or the transfer time is not shorter than a predetermined time, the CPU 101 decreases at least one of the number of pixels and the file size of the image as the target of the browsing request to generate an image that satisfies the condition concerning transfer.

Conversion of an image that is the target of a browsing request may be performed based on, for example, whether the image can be reproduced on the information-communication terminal that has transmitted the browsing request. For example, the flash memory 102 may store information including at least one of the reproducible file size, number of pixels, and file format for each information-communication terminal. The CPU 101 may determined whether the image that is the target of the browsing request is reproducible. The CPU 101 may be configured to acquire, from the information-communication terminal via the communication unit 109, information including at least one of the file size, the number of pixels, and the file format of a file reproducible on the information-communication terminal that has transmitted the browsing request. The CPU 101 converts the file size, the number of pixels, and the file format of the image as the target of the browsing request in accordance with the information to generate an image reproducible on the information-communication terminal.

In this embodiment, an example has been described in which when the user browses an image stored in the storage medium 110 using a browser, a prefix to prohibit menu display by right click is included when creating an HTML document. However, practice of the present invention is not limited to this. For example, the method of prohibiting image saving by the function of the Web browser may be implemented by including a predetermined control order in javascript or CSS. In addition, after an arbitrary image reception terminal has received an image and saved it in a cache, the control order may change the attribute of the image to disable move and copy. The control order may prohibit any operation other than an operation aiming at display or delete.

As described above, the image processing apparatus of this embodiment can avoid image saving unintended by a user who browses an image.

[Modification]

In the above-described embodiment, the HTML document that describes a control order to display a converted image includes a control order to prohibit saving of the converted image. However, the present invention may have an arrangement for notifying the user that the displayed image is not the original image.

For example, even when the control order to prohibit saving of the converted image is included, the user can acquire the converted image from a cache (not shown) in the PC 200 and save it. For this purpose, when storing a converted image, the CPU 101 may give the converted image a file name formed by including a prefix capable of identifying the converted image in the file name of the original image (image as the target of the browsing request). The prefix capable of identifying a converted image can be, for example, “temp_” or “resited_”.

Changing the file name can be performed independently of whether to include the control order to prohibit saving of the converted image in the document that describes the control order to display the converted image.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-213378, filed Sep. 28, 2011, which is hereby incorporated by reference herein in its entirety.

What is claimed is:

1. An image processing apparatus capable of communicating with an external apparatus having a Web browser, comprising:
a storage control unit configured to store content data in a storage medium; and
a transmission control unit configured to control to transmit, to the external apparatus, display content data and screen data, the screen data describes information of a display screen to display the display content data by the Web browser of the external apparatus,
wherein in a case that the content data stored in the storage medium satisfies a predetermined condition, said transmission control unit transmits the content data as the display content data, and in a case that the content data stored in the storage medium does not satisfy the predetermined condition, said transmission control unit transmits modified data generated by modifying the content data as the display content data, and
in a case that the modified data is transmitted as the display content data, said transmission control unit transmits the screen data including a restriction order to restrict, out of functions incorporated in the Web browser, at least a function of saving the display content data in the external apparatus.

2. The apparatus according to claim 1, wherein
the screen data includes information to display, on the display screen, an interface to input an instruction to save the content data in the external apparatus, and
in a case that the instruction to save the content data in the external apparatus is input, said transmission control unit transmits the content data to the external apparatus.

3. The apparatus according to claim 2, wherein
the interface includes an operation button displayed on the display screen, and
the instruction to save the content data in the external apparatus is input by clicking the operation button.

4. The apparatus according to claim 1, further comprising a generation unit configured to generate the modified data by modifying the content data in a case that the content data stored in the storage medium does not satisfy the predetermined condition,
wherein said generation unit gives the generated modified data a name different from that of corresponding content data.

5. The apparatus according to claim 4, wherein said generation unit generates, as the modified data, data obtained by decreasing size of the content data.

6. The apparatus according to claim 1, wherein the restriction order restricts displaying a list of the functions incorporated in the Web browser.

7. The apparatus according to claim 1, wherein the restriction order makes the function of saving the display content data in the external apparatus unselectable from a list of the functions incorporated in the Web browser.

8. The apparatus according to claim 1, wherein the predetermined condition concerns at least one of a file size, the number of pixels, and a file format of the content data.

9. The apparatus according to claim 1, further comprising an image capturing unit configured to obtain image data by converting an optical image,
wherein said storage control unit stores the image data obtained by said image capturing unit in the storage medium as the content data.

10. A method of controlling an image processing apparatus capable of communicating with an external apparatus having a Web browser, comprising:
storing content data in a storage medium; and
controlling to transmit, to the external apparatus, display content data and screen data, the screen data describes information of a display screen to display the display content data by the Web browser of the external apparatus,
wherein in the transmitting the content data, in a case that the content data stored in the storage medium satisfies a predetermined condition, the content data is transmitted as the display content data, and in a case that the content data stored in the storage medium does not satisfy the predetermined condition, modified data generated by modifying the content data is transmitted as the display content data, and
in the transmitting the screen data, in a case that the modified data is transmitted as the display content data, the screen data including a restriction order to restrict, out of functions incorporated in the Web browser, at least a function of saving the display content data in the external apparatus is transmitted.

11. The method according to claim 10, wherein
the screen data includes information to display, on the display screen, an interface to input an instruction to save the content data in the external apparatus, and
in a case that the instruction to save the content data in the external apparatus is input, the content data is transmitted to the external apparatus.

12. The method according to claim 11, wherein
the interface includes an operation button displayed on the display screen, and
the instruction to save the content data in the external apparatus is input by clicking the operation button.

13. The method according to claim 10, further comprising generating the modified data by modifying the content data in a case that the content data stored in the storage medium does not satisfy the predetermined condition,
wherein the generated modified data is given a name different from that of the corresponding content data.

14. The method according to claim 13, wherein data obtained by decreasing size of the content data is generated as the modified data.

15. The method according to claim 10, wherein the restriction order restricts displaying a list of the functions incorporated in the Web browser.

16. The method according to claim 10, wherein the restriction order makes the function of saving the display content data in the external apparatus unselectable from a list of the functions incorporated in the Web browser.

17. The method according to claim 10, wherein the predetermined condition concerns at least one of a file size, the number of pixels, and a file format of the content data.

18. The method according to claim 10, further comprising obtaining image data by converting an optical image,
wherein the image data obtained by the image capturing is stored in the storage medium as the content data.

19. A computer-readable storage medium storing a program that causes a computer to execute a method of claim 10.
